(19) United States
(12) Patent Application Publication
(10) Pub. No.: US 2023/0345973 A1
(43) Pub. Date: Nov. 2, 2023

(54) PET FOOD

(71) Applicant: Unicharm Corporation, Ehime (JP)

(72) Inventors: Go Ikeda, Itami-shi (JP); Hisashi Takai, Itami-shi (JP); Hiroto Yamanishi, Itami-shi (JP)

(73) Assignee: Unicharm Corporation, Ehime (JP)

(21) Appl. No.: 18/214,810

(22) Filed: Jun. 27, 2023

Related U.S. Application Data
(63) Continuation of application No. PCT/JP2021/048840, filed on Dec. 28, 2021.

(30) Foreign Application Priority Data
Dec. 28, 2020 (JP) 2020-219693
Dec. 27, 2021 (JP) 2021-213426

(51) Int. Cl. A23K 40/25

(52) U.S. Cl. CPC A23K 40/25

(57) ABSTRACT

A pet food includes a first surface on which the pet food is projected in a first direction and a plurality of openings. The pet food has an opening area ratio of 10% or more on the first surface.

### CROSS-REFERENCE TO RELATED APPLICATIONS

This application is a continuation application of International Application No. PCT/JP2021/048840, filed on Dec. 28, 2021, which claims priority to Japanese Patent Application No. 2020-219693 filed in Japan on Dec. 28, 2020, and Japanese Patent Application No. 2021-213426 filed in Japan on Dec. 27, 2021, the entire contents of which are incorporated herein by reference.

### TECHNICAL FIELD

The present invention relates to pet food.

### BACKGROUND ART

A pet food can be categorized into a staple food and in-between meal snacks in a case where the feeding purposes are categorized with opportunity. The pet food as the staple food is called a “comprehensive nutritional food” which enables a pet to take necessary nutrients so long as the pet food and water are given to it.

On the other hand, an “in-between meal snack” is a pet food that is intended to be given in a limited amount in a case of pet training and exercise, or as a reward.

As classification according to the purposes, pet foods can be categorized into a “comprehensive nutritional food,” “in-between meal snacks,” “therapy diet,” and a “food for other purposes” that does not fall under any of them.

In addition, classification according to the moisture content of pet foods is broadly categorized into dry foods having a moisture content of approximately 10% (12% or less), soft foods having a moisture content of approximately 25 to 35%, and subjected to foaming treatment, semi-moist foods having a moisture content of approximately 25 to 35%, and not subjected to foaming treatment, and wet foods having a moisture content of approximately 75%. Among these, demand for dry-type pet foods has been increasing in recent years from the viewpoints of ease of handling, good storage properties, and the like.

Dry-type pet foods are generally stiffer than other types of pet foods and, of course, are stiffer than most human-eating foods. Dogs and cats are originally carnivorous, and their teeth have evolved primarily to capture prey or to cut meat, and are not suitable for breaking hard ones with molars. For such dogs and cats, conventional hard dry-type pet foods cannot be said as easy-to-eat foods. The easy-to-grind grains are easy-to-eat grains, and the easy-to-eat property leads to a high palatability.

As a pet food that is easy to grind, although it is not a dry-type pet food, Patent Document 1 discloses an aerated pet treat as a treat that is low in calories and fat, in which the pet treat has less than about 5 kilocalories per gram weight.

### CITATION LIST

### Patent Document

### [Patent Document 1]

Published Japanese Translation No. 2016-515808 of the PCT International Publication

Although ease of grinding leads to an improvement in palatability, a pet food having chewability also improves in palatability. That is, only improving the ease of grinding the pet food by, for example, whipping the pet food as the pet food described in Patent Document 1 will reduce the chewability. Therefore, as a result, it does not lead to the improvement in palatability. In addition, in the pet food described in Patent Document 1, mixing air for whipping or the like is required, and thus the components that can be contained are limited.

### SUMMARY OF INVENTION

One or more embodiments of the present invention provide a pet food improved in palatability by making it easier to grind while maintaining the chewability.

One or more embodiments of the present invention have the following aspects.

[1] A pet food having openings, in which an opening area ratio of a first surface on which the pet food is projected in a first direction is 10% or more.

[2] The pet food according to [1], in which an opening area ratio of a surface on which the pet food is projected in a direction other than the first direction is 8% or less.

[3] The pet food according to [1] or [2], in which in a case where a surface on which the pet food is projected on an A side in a second direction that intersects the first direction is defined as a second surface, and a surface on which the pet food is projected on a B side in the second direction is defined as a third surface, an opening area ratio of at least one of the second surface and the third surface is 10% or more.

[4] The pet food according to [3], in which opening area ratios of the second surface and the third surface are each 10% or more.

[5] The pet food according to any one of [1] to [4], in which a ratio of the opening area ratio of the first surface to the opening area ratio of a cross section in a case where the pet food is cut orthogonal to the first direction (opening area ratio of first surface/opening area ratio of cross section) is 0.4 to 2.

[6] The pet food according to any one of [1] to [5], in which a ratio of the opening area ratio of the first surface to the opening area ratio of a cross section in a case where the pet food is cut such that the first surface is divided equally (opening area ratio of first surface/opening area ratio of cross section) is 0.4 to 2.

According to one or more embodiments of the present invention, the pet food improved in palatability is obtained by making it easier to grind while maintaining the chew ability.

### BRIEF DESCRIPTION OF DRAWINGS

FIG. 1 is a schematic diagram showing a pet food according to a first embodiment of the present invention.

FIG. 2 is a schematic diagram showing a projection surface on which a pet food according to a first embodiment of the present invention is projected in each direction.

FIG. 3 is a schematic diagram showing a pet food according to a second embodiment of the present invention.

FIG. 4 is a schematic diagram showing a projection surface on which a pet food according to a second embodiment of the present invention is projected in each direction.

FIG. 5 is a schematic diagram for showing a producing method of a pet food according to the present embodiment.

FIG. 6A shows an image of the first surface of the pet food of examples and FIG. 6B shows an image when measuring the opening area ratio of the first surface.

FIG. 7A shows an image of the third surface of the pet food of examples and FIG. 7B shows an image when measuring the opening area ratio of the third surface.

FIG. 8A shows an image of the fifth surface of the pet food of examples and FIG. 8B shows an image when measuring the opening area ratio of the fifth surface.

FIG. 9A shows an image when measuring the opening area ratio of the first surface of the pet food of examples and FIG. 9B shows an image when measuring the opening area ratio of the cross section.

FIG. 10A shows an image when measuring the opening area ratio of the third surface of the pet food of examples and FIG. 10B shows an image when measuring the opening area ratio of the cross section.

### DESCRIPTION OF EMBODIMENTS

In the present specification, the term “pet” refers to an animal raised by a person. In a narrower sense, pets are animals that are kept and loved by their owners. In addition, the term “pet food” refers to feed for pets. A pet food according to one or more embodiments of the present invention can be sold as a “feed for animal” or an “animal feed”.

In the present specification, the “palatability” is an index of whether or not a pet favors to eat, and is caused by texture, taste, odor, and the like.

In the present specification, a value of a moisture content is a value obtained by a “drying loss method”.

The drying loss method is a method in which a sample is heated and dried by infrared irradiation, and the amount of moisture in the sample is determined from a mass change caused by evaporation of contained moisture. The moisture content can be measured using a well-known apparatus. For example, the moisture content can be measured with an Infrared Moisture Analyzer FD-720 (manufactured by Kett Electric Laboratory Co. Ltd.).

In the present specification, the size of a pet food means a diameter in a case where the shape of the pet food is spherical, and the longest diameter in a case where the shape of the pet food is not spherical (cylindrical, polygonal columnar, plate-shaped, or the like).

(Pet Food)

The pet food of one or more embodiments is a pet food having openings.

In the present specification, the “opening” is a fine pore present on surface of or inside pet food. As the pore, a plurality of pores may be connected as a communicating pore.

On the other hand, for example, holes penetrating from the front surface of pet food to the corresponding back surface, such as a donut-shaped pet food, do not have the effect of making it easier to grind while maintaining the chewability, and thus the holes are not included in “opening”.

The pet food according to one or more embodiments may consist of only the pet food or may be a mixture of the pet food and other pet foods. Other pet foods are not particularly limited and examples thereof include dry-type pet foods, materials, flakes, and the like other than the pet foods according to one or more embodiments. It is sufficient that, in the mixture of the pet food according to one or more embodiments and other pet foods, 1% or more of the pet food according to one or more embodiments is contained with respect to the total amount of the mixture.

More specifically, the term “opening” means, for example, a pore having circle-equivalent diameter of 50 to 5000 μm.

In a case where the opening is a communicating pore, the circle-equivalent diameter means a circle-equivalent diameter in the plane view of the surface of the pet food. More specifically, the circle-equivalent diameter means, for example, a value obtained by photographing an image of the surface of a pet food using a digital microscope (trade name “VHX-7000”, manufactured by Keyence Corporation), and measuring the circle-equivalent diameter of the opening (communicating pore) with measurement/scale tool of the digital microscope using the image.

<<Opening Area Ratio of First Surface>>

In the pet food of one or more embodiments, an opening area ratio of the first surface on which the pet food is projected in the first direction is 10% or more.

The first direction is any direction. For example, in a case where the pet food of one or more embodiments is mounted on a measurement table of the above-described digital microscope and an image of a surface (top surface) opposite to the mounting surface of the pet food is photographed, a direction from the digital microscope toward the top surface of the pet food serves as the first direction. In addition, an image of the top surface of the pet food photographed with the digital microscope serves as a first surface on which the pet food is projected.

The opening area ratio of the first surface of the pet food of one or more embodiments is 10% or more, preferably 12% or more, more preferably 16% or more, still more preferably 20% or more, and particularly preferably 25% or more.

In a case where the opening area ratio of the pet food is 10% or more, the pet food becomes easier to grind and improves in palatability.

In addition, in a case where the opening area ratio of the pet food is not less than the above-described preferred value, the pet food is easier to grind and further improves in palatability.

On the other hand, the opening area ratio of the first surface of the pet food of one or more embodiments is preferably 60% or less, more preferably 55% or less, and still more preferably 50% or less.

In a case where the opening area ratio of the pet food is not more than the above-described preferred value, the pet food further improves in chewability and further improves in palatability.

For example, the opening area ratio of the first surface of the pet food of one or more embodiments is preferably 10% or more and 60% or less, more preferably 12% or more and 60% or less, still more preferably 16% or more and 55% or less, particularly preferably 20% or more and 50% or less, and most preferably 25% or more and 50% or less.

In the present specification, the “opening area ratio” means a value obtained by photographing an image of the surface of a pet food using a digital microscope (trade name “VHX-7000”, manufactured by Keyence Corporation), and measuring the opening area ratio excluding a circle-equivalent diameter of less than 50 μm with automatic area measurement (particle count) as measurement/scale tool of the digital microscope using the image.

A more specific operation procedure is as follows.

(i) Setting the magnification of the digital microscope (for example, setting to 20 times) such that the entire first surface of the pet food mounted on the measurement table is reflected.

(ii) Setting the set value of the epi-illumination to be a numerical value at which the opening is visible most between 100 and 255.

(iii) In automatic area measurement (particle count) as measurement/scale tool of the digital microscope, setting the extraction method to “brightness (standard)”.

Next, setting the extraction region on the first surface of the pet food.

(iv) In a case where the automatic area measurement (particle count) as measurement/scale tool of the digital microscope is performed excluding the circle-equivalent diameter of less than 50 μm, the porosity of the first surface of the pet food can be measured.

<<Opening Area Ratio of Other Surfaces>>

In the pet food of one or more embodiments, the opening area ratio of a surface on which the pet food is projected in a direction other than the first direction (hereinafter, also referred to as “another surface”) is preferably 8% or less. That is, it is preferable that in the pet food of one or more embodiments, a portion having a large number of openings and a portion having a small number of openings are mixed on the surface of the pet food.

The pet food of one or more embodiments has a first surface having an opening area ratio of 10% or more and another surface having an opening area ratio of 8% or less, and thus a plurality of textures can be enjoyed when grinding the pet food, and the pet food further improves in palatability.

The opening area ratio of another surface of the pet food of one or more embodiments is preferably 8% or less, more preferably 4% or less, and still more preferably 2% or less, and may be 0%.

In a case where the opening area ratio of another surface of the pet food of one or more embodiments is not more than the above-described preferred value, the difference between the opening area ratio of the first surface and the opening area ratio of another surface of the pet food is large, and thus a plurality of textures can be more enjoyed, and the pet food further improves in palatability.

<<Opening Area Ratio of Second and Third Surfaces>>

In the pet food of one or more embodiments, in addition to the first surface of the pet food described above, in a case where a surface on which the pet food is projected on A side in a second direction that intersects the first direction (which may be referred to as a +side, a first side, or one side) is defined as a second surface, and a surface on which the pet food is projected on the B side in the second direction (which may be referred to as a −side, a second side, or the other side) is defined as a third surface, an opening area ratio of at least any of the second surface and the third surface is preferably 10% or more. That is, it is preferable that in the pet food of one or more embodiments, a plurality of portions having a large number of openings are present on the surface of the pet food.

Here, the second direction typically means a direction that is “orthogonal” to the first direction, but the second direction is not limited to a direction that is orthogonal to the first direction, and may mean a predetermined direction that intersects the first direction and is orthogonal to the surface of the pet food.

For example, as a specific example in a case where the second direction is not a direction orthogonal to the first direction, in a case where the pet food of one or more embodiments has a tetrahedral shape and the bottom surface is the first surface, the direction orthogonal to the side surface of the tetrahedral pet food is the second direction.

In addition, in a case where the surface of the pet food of one or more embodiments does not represent a shape such as a spherical or a cylindrical, the second direction means a direction that is “orthogonal” to the first direction.

The preferable range of the opening area ratios of the second surface and the third surface is similar to the preferable range of the opening area ratios of the first surface described above.

In a case where the opening area ratio of at least any surface of the second surface and the third surface of the pet food of one or more embodiments is not less than the above-described preferred value, the pet food is easier to grind and further improves in palatability. In addition, in a case where the opening area ratio of at least any surface of the second surface and the third surface of the pet food of one or more embodiments is not more than the above-described preferred value, the pet food further improves in chewability and further improves in palatability.

In the pet food of one or more embodiments, the opening area ratios of the second surface and the third surface of the pet food are each preferably 10% or more, in addition to the first surface of the pet food described above.

In a case where the opening area ratio of the second surface and the third surface of the pet food of one or more embodiments is not less than the above-described preferred value, the pet food is easier to grind and further improves in palatability. In addition, in a case where the opening area ratio of the second surface and the third surface of the pet food of one or more embodiments is not more than the above-described preferred value, the pet food further improves in chewability and further improves in palatability.

In the pet food of one or more embodiments, it is preferable that the opening area ratios of the first surface, the second surface, and the third surface are each 10% or more, and the opening area ratio of at least one surface excluding the first surface, the second surface, and the third surface is 8% or less.

More specifically, in the pet food of one or more embodiments, it is preferable that the opening area ratios of the first surface, the second surface, and the third surface are each 10% or more and 60% or less, and that the opening area ratio of at least one surface excluding the first surface, the second surface, and the third surface is 8% or less, it is more preferable that the opening area ratios of the first surface, the second surface, and the third surface are each 12% or more and 60% or less, and that the opening area ratio of at least one surface excluding the first surface, the second surface, and the third surface is 4% or less, it is still more preferable that the opening area ratios of the first surface, the second surface, and the third surface are each 16% or more and 55% or less, and that the opening area ratio of at least one surface excluding of the first surface, the second surface, and the third surface is 4% or less, it is even still more preferable that the opening area ratios of the first surface, the second surface, and the third surface are each 20% or more and 50% or less, and that the opening area ratio of at least one surface excluding of the first surface, the second surface, and the third surface is 4% or less, it is particularly preferable that the opening area ratios of the first surface, the second surface, and the third surface are each 25% or more and 50% or less, and that the opening area ratio of at least one surface excluding of the first surface, the second surface, and the third surface is 4% or less, and it is most preferable that the opening area ratios of the first surface, the second surface, and the third surface are each 25% or more and 50% or less, and that the opening area ratio of at least one surface excluding the first surface, the second surface, and the third surface is 2% or less.

Furthermore, in the above-described pet food, “at least one surface excluding the first surface, the second surface, and the third surface” is preferably “two surfaces excluding the first surface, the second surface, and the third surface”.

<<Ratio of Opening Area Ratio of First Surface to Opening Area Ratio of Cross Section>>

In the pet food of one or more embodiments, the ratio of the opening area ratio of the first surface to the opening area ratio of a cross section (hereinafter referred to as cross section A) in a case where the pet food is cut orthogonal to the first direction (opening area ratio of first surface/opening area ratio of cross section A) is preferably 0.3 to 3. In other words, it is preferable that the pet food of one or more embodiments has openings not only on the surface of the pet food, but also on the inside of the pet food, from the viewpoint of further improvement in palatability.

In the pet food of one or more embodiments, the ratio of the opening area ratio of the first surface to the opening area ratio of the cross-section A is preferably 0.3 to 3, more preferably 0.35 to 2.5, and still more preferably 0.4 to 2.

In a case where the ratio of the opening area ratio of the first surface to the opening area ratio of the cross-section A is within the above-described preferred range, the pet food is easy to grind and improves in chewability, and thus the pet food improves in palatability.

In the pet food of one or more embodiments, the ratio of the opening area ratio of the first surface to the opening area ratio of a cross section (hereinafter referred to as cross section B) in a case where the pet food is cut in the first direction such that the first surface is divided equally (opening area ratio of first surface/opening area ratio of cross section B) is preferably 0.3 to 3. In other words, it is preferable that the pet food of one or more embodiments has openings not only on the surface of the pet food, but also on the inside of the pet food, from the viewpoint of further improvement in palatability.

In the pet food of one or more embodiments, the ratio of the opening area ratio of the first surface to the opening area ratio of the cross-section B is preferably 0.3 to 3, more preferably 0.35 to 2.5, and still more preferably 0.4 to 2.

In a case where the ratio of the opening area ratio of the first surface to the opening area ratio of the cross-section B is within the above-described preferred range, the pet food is easy to grind and improves in chewability, and thus the pet food improves in palatability.

In the pet food of one or more embodiments, the ratio of the opening area ratio of the first surface to the opening area ratio of the cross section A or the cross section B is preferably 0.3 to 3, more preferably 0.35 to 2.5, and still more preferably 0.4 to 2.

In addition, in the pet food of one or more embodiments, the ratio of the opening area ratio of the first surface to the opening area ratio of the cross section A and the cross section B is preferably 0.3 to 3, more preferably 0.35 to 2.5, and still more preferably 0.4 to 2.

<<Grain Density of Pet Food>>

The pet food of one or more embodiments has a grain density of preferably 600 g/L or less, more preferably 500 g/L or less, and still more preferably 400 g/L or less.

In a case where the grain density of the pet food of one or more embodiments is not more than the above-described preferred value, the pet food is easy to grind and further improves in palatability. In addition, in a case where the grain density is not more than the above-described preferred value, the mass per unit volume can be reduced while maintaining a moderate chewability, the feeling of satiety can be easily obtained, and thus the diet effect is also more improved.

(2).

The grain density of the pet food is calculated by the following formulas (1) and

Grain volume(L)=grain volume(mm³)/1,000,000 (1)

Grain density(g/L)=grain mass(g)/grain volume(L) (2)

The grain mass in the formula (2) can be measured by the following procedure.

(Step 1A) Selecting one grain of the pet food to be measured.

(Step 2A) Measuring the mass of the one grain with an electronic balance.

The grain volume in the formula (2) can be measured by the following procedure.

(Step 1B) Selecting one grain of the pet food to be measured.

(Step 2B) Calculating the grain volume with an X-ray CT apparatus (for example, CosmoScan FX (manufactured by Rigaku Corporation)).

In one or more embodiments, the following photographing conditions are adopted for the CT images in step 2B.

(Photographing Conditions for CT Images)
Tube voltage: 90 kV
Tube current: 88 μA
Irradiation time: 2 minutes
Resolution: 50 μm
Effective field of view (FOV): 25.6 mm×25.6 mm×25.6 mm
Matrix: 512×512×512

In step 2B, the area of the entire grain (grain area) in each of the CT cross-sectional images is calculated by the following procedure.

(ib) Binarizing the X-ray CT images using image analysis software (for example, Fiji) (maximum entropy method). In each of the grain cross-sectional images, subtracting the background value and calculating the dough area.

(iib) In each CT cross-sectional image, filling opening with Fill holes, Dilate/Erode processing to subtract the background value, and calculating the area of the entire grain (grain area).

In a case of the above-described condition, since the CT image is measured by dividing the effective field of view (FOV) into 512 equal portions, the thickness of one CT cross-sectional image can be considered to be 50 μm. Therefore, a thickness of 50 μm is multiplied by the grain area of one CT cross-sectional image to obtain the grain volume of one CT cross-sectional image, and the grain volume of one food grain to be measured can be calculated by adding the grain volumes of all CT cross-sectional images together.

<<Shape>>

A shape of the pet food in one or more embodiments may be any shape suitable for pets to eat, and is not particularly limited.

For example, any shape such as spherical, ellipsoidal (grid-like), pellet-shaped, cylindrical, polygonal columnar, hexahedral (plate-shaped), clover-shaped, heart-shaped, star-shaped, or cruciform-shaped is applicable. Among them, from the viewpoint of making it easier to obtain the effects of the present invention, it is preferable that the pet food has a cylindrical, polygonal columnar, or hexahedral shape, and it is more preferable that the pet food has a hexahedral shape.

<<Size>>

The pet food of one or more embodiments may have a small grain shape in which the pet can cram all into one's mouth, or may have a large grain shape in which the pet can bite multiple times, but it is preferable that the longest diameter of the pet food is 1 to 200 mm, more preferably 1 to 150 mm, and still more preferably 3 to 40 mm.

Further, it is preferable that the shortest diameter of the pet food is 1 to 100 mm, more preferably 1 to 50 mm, and still more preferably 3 to 30 mm.

<<Moisture Content>>

The moisture content of the pet food of one or more embodiments is preferably 1 to 50 mass %, more preferably 3 to 30 mass %, and still more preferably 3 to 12 mass %.

From the viewpoint that the effects of the present invention are more likely to be obtained, the pet food of one or more embodiments is preferably a dry food having a moisture content of about 10% or less, and more preferably a dry food having a moisture content of 5% to 12%.

<<Hardness>>

The hardness of the pet food of one or more embodiments is preferably 60 N or less, more preferably 50 N or less, and still more preferably 40 N or less.

In a case where the hardness of the pet food is not more than the above-described preferred value, the pet food is easy to grind and the pet food improves in palatability.

On the other hand, the hardness of the pet food of one or more embodiments is preferably 6 N or more, more preferably 8 N or more, and still more preferably 10 N or more.

In a case where the hardness of the pet food is not less than the above-described preferred value, the pet food further improves in chewability and further improves in palatability.

In the present specification, the hardness of the pet food is a value obtained by the following measurement method.

Measuring a breaking force when the pet food is compressed at a constant compression rate, using a compression tester (texture analyzer, model number: EZ-SX, manufactured by Shimadzu Corporation).

Specifically, placing one pet food to be measured on the pan, and measuring the test force while the plunger is pressed vertically from directly above at a constant rate. Reading the peak value (maximum value) of the test force as the value of the breaking force. Repeating the measurements on 10 pet foods and calculating the average value.

The unit is converted to Newtons (N) by multiplying the numerical value of the breaking force (unit: kgw) measured by the compression tester by 9.8.

Measurement conditions are as follows.
Plunger: 10 mm in width, 20 mm in length, 1 mm in thickness at the leading end, wedge-shaped plunger
Platform: a flat pan with a diameter of 100 mm
Compression rate: 60 mm/min
The lowest point of the plunger: Set to be pushed by 70% to 90% with respect to the thickness (height) of the pet food.
Measured temperature: 25° C.

In the pet food of one or more embodiments, it is preferable that the hardness of the first surface is a preferable hardness value described above. That is, in the above-described measurement method of the hardness of a pet food, the value (hardness) when the test force is measured while the plunger is pressed against the first surface of the pet food of one or more embodiments is preferably 6 N or more and 60 N or less, more preferably 8 N or more and 50 N or less, and still more preferably 10 N or more and 40 N or less.

In addition, in a case where the pet food of one or more embodiments has another surface having an opening area ratio of 8% or less, the value (hardness) when the test force is measured while the plunger is pressed against another surface of the pet food of one or more embodiments is preferably 15 N or more and 70 N or less, more preferably 20 N or more and 60 N or less, and still more preferably 25 N or more and 50 Nor less.

<<Water Absorption Rate>>

In the pet food of one or more embodiments, an opening area ratio of the first surface is 10% or more and a specific surface area is large, and thus the pet food has a higher water absorption rate than conventional pet food. In addition, since the water absorption rate is high, the hardness of the pet food can be easily changed in a short time according to the preference of the pet by immersing it in water.

Moreover, since the higher the opening area ratio is, the higher the specific surface area is and the higher the water absorption rate is, the level of the opening area ratio of the pet food of one or more embodiments can be expressed by the water absorption rate.

Water Absorption Rate for 5 Seconds

The water absorption rate for 5 seconds of the pet food of one or more embodiments is preferably 30 mass % or more, more preferably 50 mass % or more, still more preferably 80 mass % or more, particularly preferably 100 mass % or more, and most preferably 130 mass % or more.

In the present specification, the “water absorption rate for 5 seconds” is the ratio of the increase in the mass of the pet food to the original mass of the pet food when the pet food is immersed in water for 5 seconds at a constant temperature.

In the present specification, regarding the temperature of water when measuring the water absorption rate, the water absorption rate typically means a value measured with water at 20° C., but, for example, may be a value measured with water at 5° C. to 60° C. or a value measured with water at 15° C. to 30° C. The lower the temperature is, the lower the water absorption rate is. Therefore, in a case where the water absorption rate for 5 seconds measured with water at a lower temperature is equal to or more than the above-described preferable value, it can be said that the water absorption of the pet food is higher.

Water Absorption Rate for 30 Seconds

The water absorption rate for 30 seconds of the pet food of one or more embodiments is preferably 40 mass % or more, more preferably 60 mass % or more, still more preferably 100 mass % or more, particularly preferably 120 mass % or more, and most preferably 150 mass % or more.

In the present specification, the “water absorption rate for 30 seconds” is the ratio of the increase in the mass of the pet food to the original mass of the pet food when the pet food is immersed in water for 30 seconds at the above-described temperature.

Water Absorption Rate for 60 Seconds

The water absorption rate for 60 seconds of the pet food of one or more embodiments is preferably 50 mass % or more, more preferably 70 mass % or more, still more preferably 120 mass % or more, particularly preferably 140 mass % or more, and most preferably 160 mass % or more.

In the present specification, the “water absorption rate for 60 seconds” is the ratio of the increase in the mass of the pet food to the original mass of the pet food when the pet food is immersed in water for 60 seconds at the above-described temperature.

For example, the pet food of one or more embodiments is preferably a pet food in which the opening area ratio of the first surface is 10% or more and the water absorption rate for 5 seconds measured in water at 20° C. is not less than the above-described preferred value.

In addition, the pet food of one or more embodiments is preferably a pet food in which the opening area ratio of the first surface is 10% or more and the water absorption rate for 30 seconds measured in water at 20° C. is not less than the above-described preferred value.

In addition, the pet food of one or more embodiments is preferably a pet food in which the opening area ratio of the first surface is 10% or more and the water absorption rate for 60 seconds measured in water at 20° C. is not less than the above-described preferred value.

<<Measurement Method of Water Absorption Rate>>

Water Absorption Rate for 5 Seconds

The water absorption rate for 5 seconds is a value obtained by the following method.

(Step 1) First, a predetermined amount of the grain of the pet food is placed in a container containing water, and the grains of the pet food are immersed in water.

(Step 2) After 5 seconds have elapsed while the grains of the pet food are immersed in water, the pet food grains are immediately collected from the container and drained.

In Step 2, draining is not particularly limited as long as it is a well-known method. For example, a method of leaving the collected grains of the pet food on Kimtowel (manufactured by NIPPON PAPER CRECIA Co., LTD.) for 3 seconds is recommended, but a method of shaking the collected grains of the pet food for about 1 to 10 seconds while being held between nets or the like, or the like may also be used.

The water absorption rate for 5 seconds can be calculated as the following expression (1), by subtracting the mass of the pet food in (Step 1) from the mass of the pet food after (Step 2) and dividing the resulting subtracted value by the mass of the pet food in (Step 1).

Water absorption rate for 5 seconds(mass %)=(mass(g) of pet food after(step 2)−(mass(g) of pet food in (step 1))/mass(g) of pet food in (step1)×100 (1)

The predetermined amount in (Step 1) is, for example, 20 g.

Water Absorption Rate for 30 Seconds and Water Absorption Rate for 60 Seconds

The water absorption rate for 30 seconds and the water absorption rate for 60 seconds were each obtained in the same manner as the measurement method of water absorption rate for 5 seconds except that the time of immersion in water was changed to 30 seconds or 60 seconds in (Step 2) for the water absorption rate for 5 seconds described above.

<<Water Activity>>

The water activity of the pet food of one or more embodiments is preferably less than 0.65.

The spoilage of pet foods occurs mainly due to the degradation of proteins by bacteria and fungi. Depending on the type of microorganism that grows, it may cause food poisoning. In addition to the presence of nutrients and an appropriate temperature, the presence of an appropriate amount of water is essential for the growth of microorganisms. However, microorganisms can not utilize the entire water in the pet food, but can utilize the moisture, referred to as “free water”.

Moisture in the pet food is largely categorized into “bound water” and “free water” depending on the presence state of the pet food.

“Bound water” is water that is bound by hydrogen bonds to other components (proteins, carbohydrates, and the like) in pet foods, and in which the movement of the molecules is restricted. Therefore, “bound water” is not frozen even at 0° C., is not easily vaporized even at a high temperature, and is not utilized by microorganisms.

On the other hand, the term “free water” is water in which the molecules can freely move around, and is represented by an index of water activity. “Water activity” is a value obtained by dividing the water vapor pressure of a food by the water vapor pressure of pure water under the same condition. The water activity has a large influence on the oxidation of lipids and the growth of microorganisms present in pet foods.
Water activity (Aw)=P/P₀
P: water vapor pressure of pet food
P₀: water vapor pressure of pure water

<<Hardness (Degree of Hardness) of Grain of Pet Food>>

Hardness of Grain of Pet Food Immersed in Water for 5 Seconds

In one or more embodiments, the hardness of the grains of the pet food immersed in water for 5 seconds is preferably 50 N or less, more preferably 40 N or less, still more preferably 30 N or less, particularly preferably 20 N or less, and most preferably 10 N or less.

In the present specification, “hardness of grains of pet food immersed in water for 5 seconds” means the hardness of the pet food after immersing the pet food in water for 5 seconds, which is obtained by the method described above.

Hardness of Grain of Pet Food Immersed in Water for 30 Seconds

In one or more embodiments, the hardness of the grains of the pet food immersed in water for 30 seconds is preferably 30 N or less, more preferably 25 N or less, still more preferably 15 N or less, particularly preferably 10 N or less, and most preferably 5 N or less.

In the present specification, “hardness of grains of pet food immersed in water for 30 seconds” means the hardness of the pet food after immersing the pet food in water for 30 seconds, which is obtained by the method described above.

Hardness of Grain of Pet Food Immersed in Water for 60 Seconds

In one or more embodiments, the hardness of the grains of the pet food immersed in water for 60 seconds is preferably 20 N or less, more preferably 15 N or less, still more preferably 10 N or less, particularly preferably 5 N or less, and most preferably 4 N or less.

In the present specification, “hardness of grains of pet food immersed in water for 60 seconds” means the hardness of the pet food after immersing the pet food in water for 60 seconds, which is obtained by the method described above.

For the hardness after immersion for 5 seconds, the hardness after immersion for seconds, and the hardness after immersion for 60 seconds, the pet food immersed in water can be obtained in the same steps as (step 1) and (step 2) described above. In addition, the hardness of the grains of the pet food immersed in water for 5 seconds, 30 seconds, or 60 seconds is a hardness of the pet food measured within 20 seconds (preferably within 10 seconds) after draining in the above-described (step 2).

In the pet food of one or more embodiments, an opening area ratio of the first surface is 10% or more, and thus the pet food is easy to grind while maintaining the chewability, and has high palatability. On the other hand, the palatability of the pet may change depending on the health condition, growth situation, or the like, and the preference for hardness of pet food may change.

In the pet food of one or more embodiments, an opening area ratio of the first surface is 10% or more and a specific surface area is large, and thus the water absorption rate is also high and the hardness of pet food can be softened in a short time by immersing the pet food of one or more embodiments in water.

Therefore, the pet food of one or more embodiments has excellent properties in which it can easily be changed to a desired hardness by being immersed in water, with the property in which it is easy to grind while maintaining the chewability.

<<Raw Material>>

As the raw material of the pet food of one or more embodiments, well-known powder raw material and liquid raw material can be used in the producing of the pet food. The following raw material of the pet food may be used singly or may be used in mixture of two or more kinds.

Specific examples of powder raw material and liquid raw material include: cereals (maize, grain sorghum, wheat, barley, brown rice, oats, rye, wheat flour, rice flour, corn flour, wheat bran, rice, wheat germ, wheat gluten, corn gluten feed, corn gluten meal, bread crumb, and the like); potatoes (sweet potato, white potato, and the like); beans (soybeans, broad beans, adzuki bean, pea, defatted soybeans, soybean meal, soybean flour, soy flour, soybean protein, soybean curd refuse, and the like); starches (corn starch, potato starch, tapioca starch, wheat starch, rice starch, white potato starch, sweet potato starch, sago starch, and the like); meats (meats such as beefs, porks, rams, muttons, chickens, turkeys, and poultry, viscera such as lever, meat extract powders and liquids thereof, its products such as pork meals, chicken meals, beef meals, and mixed meals thereof); fishes and shellfishes (fishes such as tuna, bonito, salmon, codfish, horse mackerel, and sardine, crustaceans such as shrimp and crab, shellfishes, its product such as fish meal, fish extract powders and liquids, dried bonito, and the like); eggs (chicken eggs (whole eggs, dried whole eggs, egg yolk, egg white), and the like); vegetables (carrots, cabbages, green pea, squash, beet pulp, and the like); nuts; mushrooms; saccharides (sugars, glucose, fructose, isomerized sugar, oligosaccharides, starch syrup, syrup, molasses, honey, and the like); milks (whole milk, skim milk, whole milk powder, skim milk powder, whey, cheese, butter, cream, and the like); oils and fats (animal oil and fat (beef tallow, lard, chicken fat, fish oil, and the like); vegetable oils (soybean oil, sesame oil, germ oil, palm oil, corn oil, olive oil, coconut oil, and the like), fatty acid, and the like); dried yeasts and their extract powders and liquids; dietary fibers (cellulose, and the like); herbs; vitamins; minerals; amino acids, sweeteners; colorants; preservatives; thickening agents; modified starch; antioxidants; pH adjusters; seasonings; emulsifiers; baking powder; and aromatics.

Among the above, the pet food of one or more embodiments contains preferably cereals and meats.

In the pet food of one or more embodiments, the content of cereals is preferably to 90 mass %, more preferably 15 to 80 mass %, and still more preferably 20 to 70 mass % with respect to the total amount of the pet food.

In the pet food of one or more embodiments, the content of meats is preferably 1 to 40 mass %, more preferably 3 to 30 mass %, and still more preferably 5 to 20 mass % with respect to the total amount of the pet food.

Among them, the composition of the pet food of one or more embodiments is preferably mixtures of (a) cereals, (b) beans, (c) meats, (d) fishes and shellfishes, (e) dietary fiber, (f) dried yeast or its extract powder or liquid, (g) vegetables, (h) vitamins and minerals, and (i) oils and fats. As necessary, the mixture may contain colorants, antioxidants, and seasonings.

In addition, as the configuration of the pet food in one or more embodiments, a mixture of (a) cereals, (b) beans, (c) meats, (d) fishes and shellfishes, (e) dietary fiber, (f) dried yeast or its extract powder or liquid, (g) vegetables, (h) vitamins and minerals, (i) oils and fats, (j) starches, (k) eggs, (l) saccharides, and (m) milks may be used. If necessary, the mixture may contain a colorant, preservatives; thickening agents; antioxidants; pH adjusters; seasonings; emulsifiers; and aromatics.

A formulation example of the pet food (dry food) in the case of a comprehensive nutritional food will be described below.

A formulation is adjusted to be cereals (10 to 90 mass %), beans (0 to 40 mass %), meats (0 to 40 mass %), fishes and shellfishes (0 to 40 mass %), dietary fibers (0 to 20 mass %), dried yeast or its extract powder or liquid (0 to 10 mass %), vegetables (0 to 20 mass %), vitamins and minerals (0 to 10 mass %), oils and fats (0 to 20 mass %), colorants (0 to 5 mass %), antioxidants (0 to 5 mass %), and seasonings (0 to 5 mass %).

Hereinafter, the pet food according to a first embodiment and a second embodiment will be described in detail with reference to the drawings.

In the following description, an X, Y, and Z orthogonal coordinate system will be used as necessary. In this case, the Z direction represents the height direction (gravitational direction). Two directions orthogonal to the Z direction are the X direction and the Y direction. In the figure, the arrow side is defined as a plus (+) side, and the side opposite to the arrow is referred to as a minus (—) side. For example, the +Z side corresponds to an upper side in the height direction, and the —Z side corresponds to a lower side in the height direction.

(Pet Food According to the First Embodiment of the Present Invention)

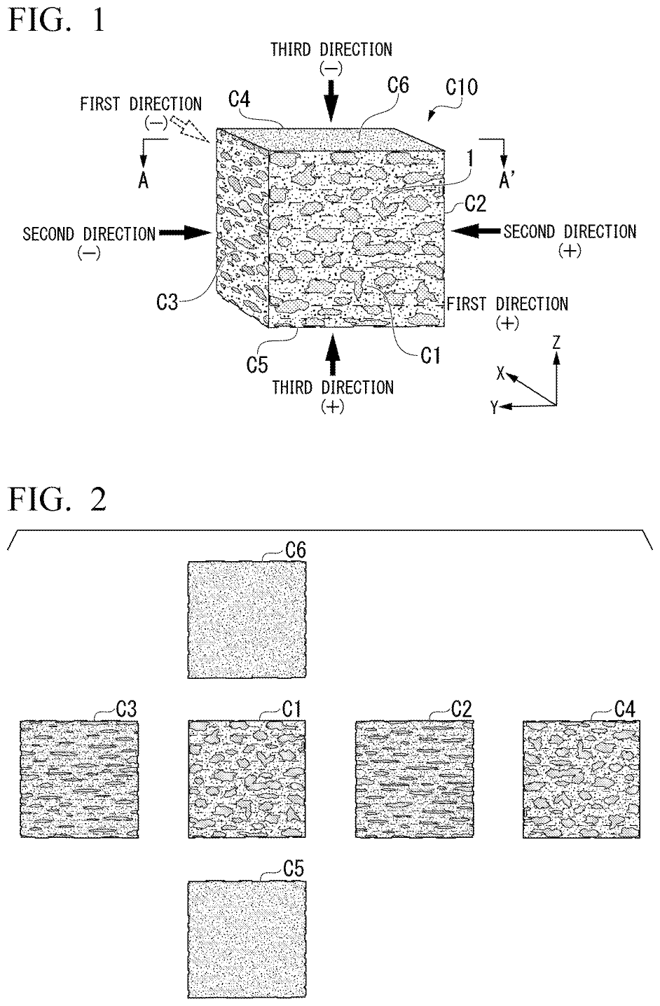

A pet food C10 according to the first embodiment of the present invention will be described in detail with reference to FIG. 1.

The pet food C10 is a hexahedral pet food. In the pet food C10, the four side surfaces (side circumferential surfaces) of the pet food C10 are surfaces having many openings 1 compared with the top surface and the bottom surface.

As shown in FIG. 1, the first direction matches the X direction, the second direction matches the Y direction, and the third direction matches the Z direction. That is, two directions orthogonal to the first direction are the second direction and the third direction.

The pet food C10 is a hexahedral pet food, and since two directions orthogonal to the first direction are the second direction and the third direction, the first surface C1 on which the pet food C10 is projected on the A side (+X side) in the first direction matches the side surface on A side of the pet food C10 in the first direction.

In the pet food C10, the opening area ratio of the first surface C1 obtained by projecting the pet food C10 on the A side (+X side) in the first direction is 10% or more.

In the pet food C10, a surface on which the pet food C10 is projected on the A side (+X side) in the first direction is the first surface C1. In addition, a surface on which the pet food C10 is projected on the B side (−X side) in the first direction is the fourth surface C4.

In the pet food C10, a surface on which the pet food C10 is projected on the A side (+Y side) in the second direction that is orthogonal to the first direction is the second surface C2. In addition, a surface on which the pet food C10 is projected on the B side (−Y side) in the second direction that is orthogonal to the first direction is the third surface C3.

In the pet food C10, a surface on which the pet food C10 is projected on the A side (+Z side) in the third direction that is orthogonal to the first direction is the fifth surface C5. In addition, a surface on which the pet food C10 is projected on the B side (−Z side) in the third direction that is orthogonal to the first direction is the sixth surface C6.

FIG. 2 is a diagram illustrating surfaces on which the pet food C10 is projected in each direction, that is, the first surface C1 to the sixth surface C6.

In the pet food C10, the first surface C1 to the fourth surface C4 are surfaces having an opening area ratio of 10% or more, and the fifth surface C5 and the sixth surface C6 are surfaces having an opening area ratio of 8% or less.

A preferred range of each of the opening area ratios of the first surface C1 to the fourth surface C4 in the pet food C10 is as described above, and for example, preferably 10% or more and 60% or less, more preferably 12% or more and 60% or less, still more preferably 16% or more and 55% or less, particularly preferably 20% or more and 50% or less, and most preferably 25% or more and 50% or less.

A preferred value of the opening area ratios of the fifth surface C5 and the sixth surface C6 in the pet food C10 is preferably 8% or less, more preferably 4% or less, and still more preferably 2% or less, and may be 0%.

In addition, as described above, in the pet food C10, the projected first surface C1 matches the side surface on A side in the first direction of the pet food C10, and thus in the pet food C10, the bottom surface and the top surface are surfaces having an opening area ratio of 8% or less, and the four side circumferential surfaces are each surface having an opening area ratio of with 10% or more.

In the pet food C10, a ratio of the opening area ratio of the first surface C1 to the opening area ratio of a cross section (A to A′ cross section:plane parallel to the first surface C1) in a case where the pet food C10 is cut orthogonal to the first direction (opening area ratio of first surface C1/opening area ratio of cross section) is 0.4 to 2.0. A preferred range of the ratio of the opening area ratio is as described above.

Preferred grain density, size, moisture content, hardness, and raw material of pet food C10 are as described above.

The pet food C10 described above has a surface having a high opening area ratio, and is thus easy to grind while maintaining the chewability. In addition, the pet food C10 has both a surface having a high opening area ratio and a surface having a low opening area ratio, and thus a plurality of textures can be enjoyed, and the palatability is higher.

In the pet food C10, the first surface C1 to the fourth surface C4 are surfaces having an opening area ratio of 10% or more, and the fifth surface C5 and the sixth surface C6 are surfaces having an opening area ratio of 8% or less, but the fourth surface C4 and the second surface C2 or the third surface C3 may be surfaces having an opening area ratio of 8% or less. In addition, the fifth surface C5 or the sixth surface C6 may be a surface having an opening area ratio of 10% or more.

As described above, in a case where the pet food according to the present embodiment has a hexahedral shape and the two directions orthogonal to the first direction are the second direction and the third direction, the surface on which the pet food is projected on the A side (+X side) in the first direction matches the side surface on the A side of the pet food C10 in the first direction.

That is, the present embodiment has the following aspects.

“1” A pet food that is hexahedral and has openings, the pet food having an A surface having an opening area ratio of 10% or more.

“2” The pet food according to “1”, further including a B surface having an opening area ratio of 8% or less.

“3” The pet food according to “1” or “2”, in which at least one surface of the four surfaces adjacent to the A surface has an opening area ratio of 10% or more.

“4” The pet food according to “1” or “2”, in which at least two surfaces of the four surfaces adjacent to the A surface has an opening area ratio of 10% or more.

“5” The pet food according to any one of “1” to “4”, in which in a case where the pet food is cut such that a plane parallel to the A surface is formed, to prepare a cross section, a ratio of the opening area ratio of the A surface and the opening area ratio of the cross section (the opening area ratio of the A surface/the opening area ratio of the cross section) is 0.4 to 2.0.

“6” A pet food that is hexahedral and has openings, in which the opening area ratio of the bottom surface and the top surface of the pet food is 8% or less, and the opening area ratio of the side circumferential surfaces (all four surfaces) are all 10% or more.

(Pet Food According to the Second Embodiment of the Present Invention)

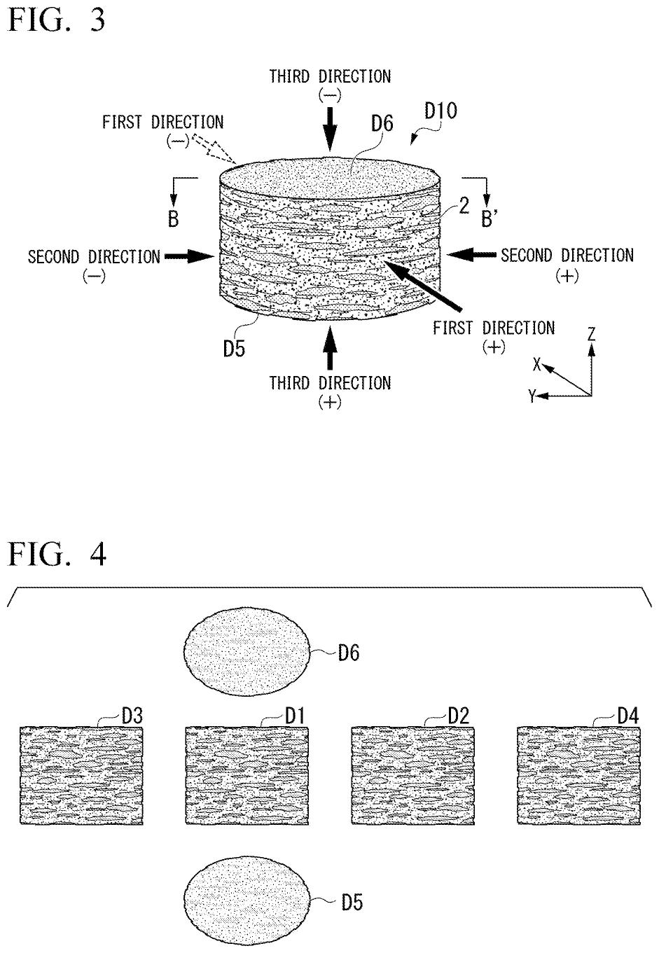

A pet food D10 according to the second embodiment of the present invention will be described in detail with reference to FIG. 3.

The pet food D10 is a cylindrical pet food. In the pet food D10, the side circumferential surface is a surface having many openings 2, and the top surface and the bottom surface of the pet food D10 are surfaces having few openings 2.

As shown in FIGS. 3 and 4, the first direction matches the X direction, the second direction matches the Y direction, and the third direction matches the Z direction. That is, two directions orthogonal to the first direction are the second direction and the third direction.

In the pet food D10, the opening area ratio of the first surface D10 obtained by projecting the pet food D10 on the A side (+X side) in the first direction is 10% or more.

In the pet food D10, a surface on which the pet food D10 is projected on the A side (+X side) in the first direction is the first surface D1. In addition, a surface on which the pet food D10 is projected on the B side (−X side) in the first direction is the fourth surface D4.

In the pet food D10, a surface on which the pet food D10 is projected on the A side (+Y side) in the second direction that is orthogonal to the first direction is the second surface D2. In addition, a surface on which the pet food D10 is projected on the B side (−Y side) in the second direction that is orthogonal to the first direction is the third surface D3.

In the pet food D10, a surface on which the pet food D10 is projected on the A side (+Z side) in the third direction that is orthogonal to the first direction is the fifth surface D5. In addition, a surface on which the pet food D10 is projected on the B side (−Z side) in the third direction that is orthogonal to the first direction is the sixth surface D6.

Since the pet food D10 has a cylindrical shape, the fifth surface D5 and the top surface of the pet food D10, and the sixth surface D6 and the bottom surface of the pet food D10 are only matched.

FIG. 4 is a diagram illustrating surfaces in which the pet food D10 is projected in each direction, that is, the first surface D1 to the sixth surface D6.

In the pet food D10, the first surface D1 to the fourth surface D4 are surfaces having an opening area ratio of 10% or more, and the fifth surface D5 and the sixth surface D6 are surfaces having an opening area ratio of 8% or less.

A preferred range of each of the opening area ratios of the first surface D1 to the fourth surface D4 in the pet food D10 is as described above, and for example, preferably 10% or more and 60% or less, more preferably 12% or more and 60% or less, still more preferably 16% or more and 55% or less, particularly preferably 20% or more and 50% or less, and most preferably 25% or more and 50% or less.

A preferred value of the opening area ratios of the fifth surface D5 and the sixth surface D6 in the pet food D10 is preferably 8% or less, more preferably 4% or less, and still more preferably 2% or less, and may be 0%.

In addition, as described above, in the pet food D10, since the fifth surface D5 and the top surface of the pet food D10, and the sixth surface D6 and the bottom surface of the pet food D10 are only matched, the bottom surface and the top surface are surfaces having an opening area ratio of 8% or less, and the side circumferential surface is a surface having an opening area ratio of with 10% or more.

In the pet food D10, a ratio of the opening area ratio of the first surface D1 to the opening area ratio of a cross section (B to B′ cross section) in a case where the pet food D10 is cut orthogonal to the first direction (opening area ratio of first surface D1/opening area ratio of cross section) is 0.4 to 2.0. A preferred range of the ratio of the opening area ratio is as described above.

Preferred grain density, size, moisture content, hardness, and raw material of pet food D10 are as described above.

The pet food D10 described above has a surface having a high opening area ratio, and is thus easy to grind while maintaining the chewability. In addition, the pet food D10 has both a surface having a high opening area ratio and a surface having a low opening area ratio, and thus a plurality of textures can be enjoyed, and the palatability is higher.

In the pet food D10, the first surface D1 to the fourth surface D4 are surfaces having an opening area ratio of 10% or more, and the fifth surface D5 and the sixth surface D6 are surfaces having an opening area ratio of 8% or less, but the fourth surface D4 and the second surface D2 or the third surface D3 may be surfaces having an opening area ratio of 8% or less. That is, the pet food D10 may have openings in a part of the side circumferential surfaces instead of the entire side circumferential surfaces. In addition, the fifth surface D5 or the sixth surface D6 may be a surface having an opening area ratio of 10% or more. That is, the bottom surface or the top surface of the pet food D10 may be a surface having an opening area ratio of 10% or more.

(Producing Method of Pet Food)

Examples of the producing method of the pet food of the present embodiment include a producing method of the pet food including a swelling step of swelling the kneaded raw material mixture by extrusion from an extruder to obtain a swollen dough, a porosification step of making the swollen dough porous to obtain a porous dough, and a cutting step of cutting the porous dough.

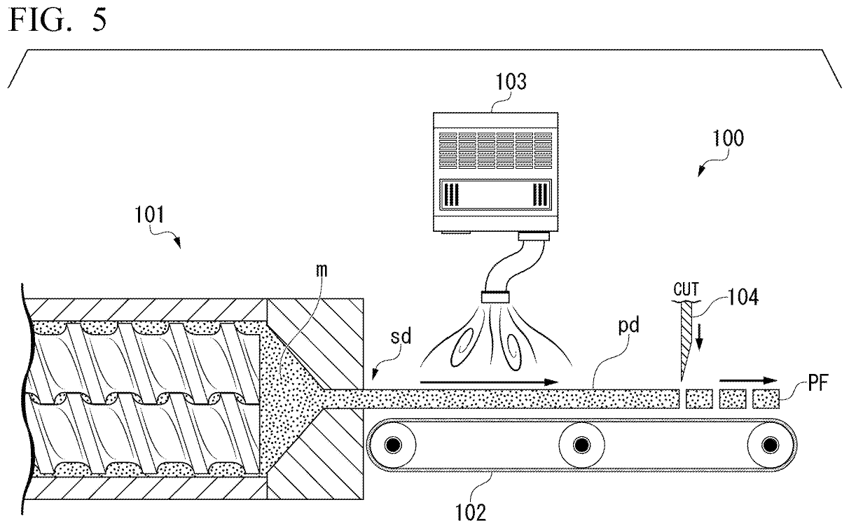

As a specific example of the producing method of the pet food of the present embodiment, the producing method 100 of the pet food will be described in detail with reference to FIG. 5.

As shown in FIG. 5, a raw material mixture is kneaded in an extruder 101, and the raw material mixture is extruded from the extruder to obtain swollen dough sd. The obtained swollen dough sd is transported by the belt conveyor 102. The transported swollen dough sd is cooled by the cooler 103 to be made porous to obtain a porous dough pd that has been made porous. The obtained porous dough pd is cut with the cutter 104 to obtain the pet food PF of the present embodiment.

[Swelling Step]

The swelling step is a step of swelling the raw material mixture kneaded in the extruder 101 by extrusion from the extruder to obtain a swollen dough sd.

The extruder 101 is not particularly limited, and a well-known single-screw or twin-screw extruder or the like can be used.

The temperature of the raw material mixture when the raw material mixture is kneaded in the extruder 101 is, for example, preferably 75° C. to 140° C., more preferably 80° C. to 135° C., and still more preferably 85° C. to 130° C.

[Porosification Step]

The porosification step is a step of making the swollen dough sd porous to obtain a porous dough pd.

Specific examples of the porosification step include a step of placing the swollen dough sd under atmospheric pressure and cooling the swollen dough sd with the cooler 103.

The cooler 103 is not particularly limited, and a well-known spot cooler or the like can be used.

[Cutting Step]

The cutting step is a step of cutting the porous dough pd with the cutter 104. When the porous dough pd is cut by the cutter 104, the porous dough pd may be cut from the machine direction (MD), may be cut from the cross direction (CD), or may be cut from any direction of the MD or the CD. Here, MD refers to the direction in which the porous dough pd flows (also referred to as the direction in which the swollen dough sd extruded from the extruder flows). CD is a direction orthogonal to the direction in which the porous dough pd flows.

The temperature of the porous dough pd when the porous dough pd is cut with the cutter 104 is preferably, for example, 70° C. or less.

By the above method, a pet food having openings, in which an opening area ratio of the first surface on which the pet food is projected in the first direction is 10% or more can be obtained.

The above-described producing method of a pet food includes a porosification step, and thus the above-described pet food can be produced easily. Specifically, in a conventional producing method of a pet food, for example, it is common that a cutter is provided at the outlet of the extruder, and the raw material mixture is cut with the cutter at the moment it is extruded from the extruder as described in “Small Animal Clinical Nutrition, 5th edition” (edited by Michael S. Hand, Craig D. Thatcher, Rebecca L. Remillard, Philip Roudebusg, Bruce J. Novotny, published by Mark Morris Associates; 2014; p. 209 to p. 215). On the other hand, in the producing method of a pet food of the present embodiment, after the raw material mixture is extruded from the extruder, the pet food is made porous by leaving a time before being cut with a cutter. Therefore, according to the producing method of a pet food of the present embodiment, the above-described pet food can be easily produced.

In the porosification step in the pet food producing method 100, cooling by the cooler 103 may be performed in a batch manner by moving the swollen dough extruded from the extruder outside the line.

In addition, in the porosification step in the pet food producing method 100, the swollen dough sd is cooled by the cooler 103, but the cooler 103 may not be used. That is, the step of cooling the swollen dough sd at room temperature may be performed by increasing the length of the belt conveyor 102. For example, the length of the belt conveyor 102 may be prepared, and the swollen dough sd may be placed at room temperature (25° C.) from the time of extrusion from the extruder to the time of cutting, for example, for 1 minute or more.

<Other Producing Method>

The producing method of the pet food of the present embodiment may be a method other than the above-described producing method, and for example, the pet food of the present embodiment may be produced using a raw material that generates gas by heating. Specific examples of the raw material that generates gas include sodium bicarbonate and the like.

### EXAMPLES

Hereinafter, embodiments of the present invention will be further described in detail using examples, but the present invention is not limited to these examples.

(Production of Pet Food Having Openings 1)

### Example 1

Raw materials constituting a pet food were mixed in a formulation shown in Table 1 to obtain raw material mixture. Water was added to the raw material mixture by a preconditioner in an amount of 12 to 25 parts by mass with respect to 100 parts by mass of the total amount of the raw material mixture, and the mixture was mixed while heating at 70° C. to 100° C. for 5 seconds to 3 minutes. The heated raw material mixture was put into an extruder, and heat treatment was performed at 80° C. to 125° C. for 10 seconds to 2 minutes while kneading to gelatinize a starch component, and then discharged from the extruder to obtain a swollen dough. The obtained dough was cooled with a cooler such that the surface temperature of the dough was 70° C. or less to obtain a porous dough. Next, the obtained dough was cut with a cutter from MD and CD to have a hexahedral shape, and pet foods of Examples 1 having a hexahedral shape and having openings (a longitudinal length of 8 mm (X direction)×a lateral length of 8 mm (Y direction)×a height (thickness) of 11.5 mm (Z direction)) were obtained. The pet food of Example 1 was in the same aspect as the pet food C10 shown in FIG. 1, and the surface cut with the cutter was the side circumferential surface. In addition, the first surface C1 of the pet food of Example 1 and the first surface C1 of the pet food C10 shown in FIG. 1 were matched, the third surface of the pet food of Example 1 and the third surface C3 of the pet food C10 shown in FIG. 1 were matched, and the fifth surface of the pet food of Example 1 and the fifth surface C5 of the pet food C10 shown in FIG. 1 were matched. In addition, the moisture content of the pet food of Example 1 determined by the “drying loss method” described above was 8.4%.

TABLE 1

| | Formulation |
|---|---|
| Raw material | ratio (mass %) |
| Cereals | 60 |
| Beans | 8 |
| Meats | 13 |
| Dietary fibers | 5 |
| Yeasts | 3 |
| Vegetables | 2 |
| Vitamins and minerals | 2.5 |
| Oils and fats | 6.5 |
| Total | 100 |

(Preparation of Pet Food Having Openings)

### Comparative Examples 1 to 7

As pet foods of Comparative Examples 1 to 7, 7 types of commercially available pet foods (commercial products A to G) were prepared.

<Evaluation of Opening Area Ratio>

Surface Measurement

An image of the surface of the pet food of each example using a digital microscope (trade name “VHX-7000”, manufactured by Keyence Corporation) was photographed, and the opening area ratio of the first surface of the pet food of each example was measured excluding a circle-equivalent diameter of less than 50 μm with automatic area measurement (particle count) as measurement/scale tool of the digital microscope using the image. Regarding the pet food of Example 1, in addition to the first surface, the opening area ratio was also measured for the third surface and the fifth surface.

A specific method is as follows.

(i) The magnification of the digital microscope was set to 20 times such that the entire specific surface of the pet food of each example mounted on the measurement table was reflected.

(ii) The set value of the epi-illumination was set to a numerical value at which the opening is visible most between 100 and 255.

(iii) In automatic area measurement (particle count) as measurement/scale tool of the digital microscope, setting the extraction method to “brightness (standard)”. Next, the extraction region on the first surface of the pet food was set.

(iv) The circle-equivalent diameter of less than 50 μm was excluded, and the porosity was measured with the automatic area measurement (particle count) as measurement/scale tool of the digital microscope.

The results are shown in Table 2 as “surface opening area ratio (%)”.

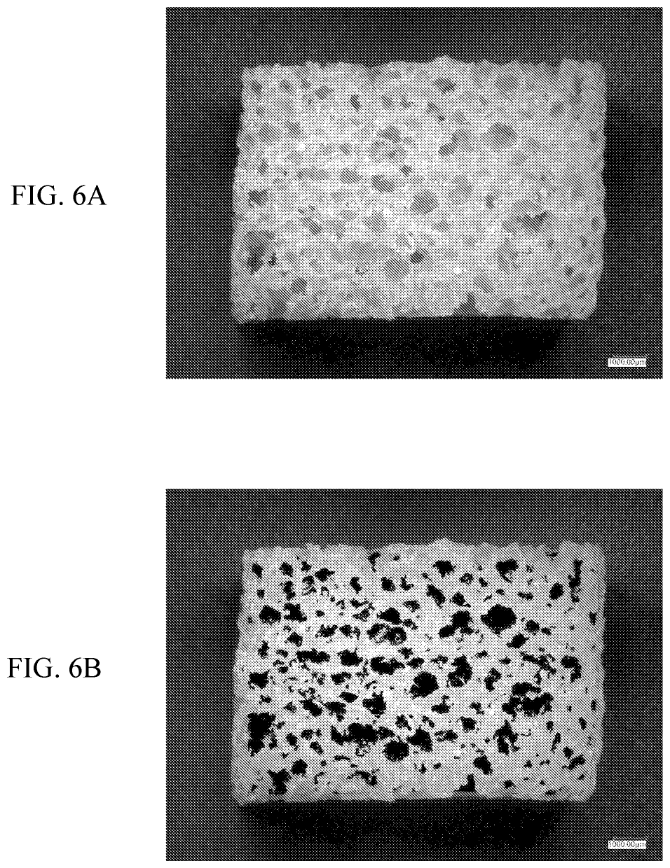

FIG. 6 shows an image of the first surface of the pet food of Example 1 and an image when measuring the opening area ratio of the first surface. FIG. 6A shows an image of the first surface, and FIG. 6B shows an image when measuring the opening area ratio. In FIG. 6B, the portions applied with the color represent openings (the same applies hereinafter).

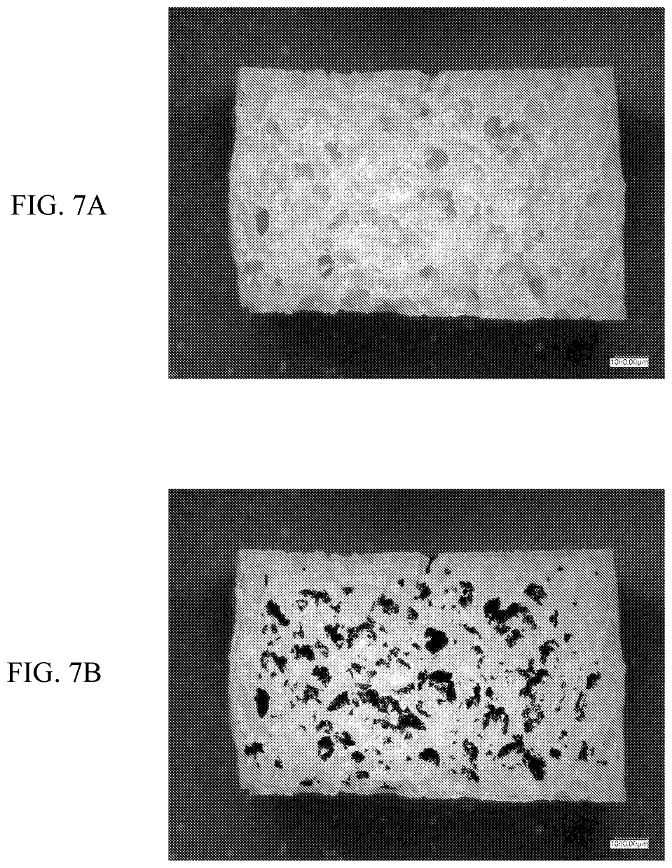

FIG. 7 shows an image of the third surface of the pet food of Example 1 and an image when measuring the opening area ratio of the third surface. FIG. 7A shows an image of the third surface, and FIG. 7B shows an image when measuring the opening area ratio.

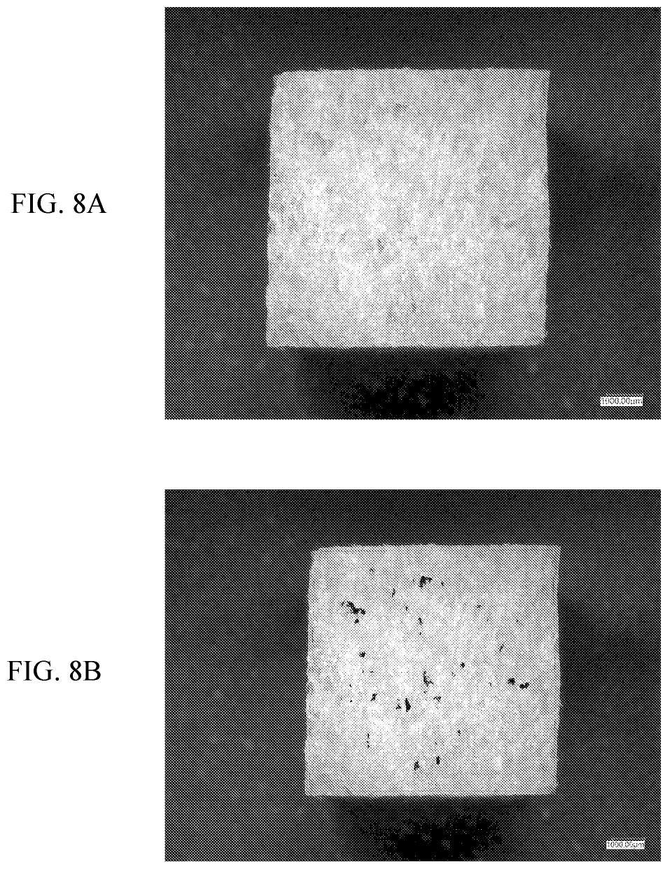

FIG. 8 shows an image of the fifth surface of the pet food of Example 1 and an image when measuring the opening area ratio of the fifth surface. FIG. 8A shows an image of the fifth surface, and FIG. 8B shows an image when measuring the opening area ratio.

Cross Section Measurement

The pet food of each example was cut orthogonal to the first direction with a cutter, and the pet food of each example was equally divided. The opening area ratio of the cross section of the cut pet food of each example was measured in the same manner as the above-described “surface measurement”.

Regarding the pet food of Example 1, the pet food of Example 1 was separately prepared, the pet food was cut orthogonal to the second direction with a cutter, and the pet food was equally divided. The opening area ratio of the cross section (plane parallel to the third surface) of the pet food was measured in the same manner as the above-described “surface measurement”.

The results are shown in Table 2 as “cross section opening area ratio (%)”.

Calculation of Ratio of Opening Area Ratio

In the pet food of each example, a ratio of an opening area ratio of the first surface (opening area ratio measured in the above-described “surface measurement”) to an opening area ratio of the cross section (opening area ratio measured by the above-described “cross section measurement”) (opening area ratio of the first surface/opening area ratio of the cross section) was determined. For the pet food of Example 1, in the same manner, a ratio of the opening area ratio of the third surface to the opening area ratio of the cross section (a plane parallel to the third surface) (opening area ratio of the third surface/opening area ratio of the cross section) was also determined.

The results are shown in Table 2 as “ratio of opening area ratio”.

TABLE 2

| | | | Cross | |
|---|---|---|---|---|
| | | Surface | section | |
| | | opening | opening | Ratio of |
| | | area ratio | area ratio | opening |
| | | (%) | (%) | area ratio |
| Example 1 | The first surface | 25.92 | 21.95 | 1.18 |
| | The third surface | 17.22 | 19.38 | 0.89 |
| | The fifth surface | 1.16 | | |

| | | | |
|---|---|---|---|
| Comparative Example 1 | 0.25 | 17.66 | 0.01 |
| (commercial product A) | | | |
| Comparative Example 2 | 3.39 | 34.17 | 0.1 |
| (commercial product B) | | | |
| Comparative Example 3 | 0.34 | 19.26 | 0.02 |
| (commercial product C) | | | |
| Comparative Example 4 | 1.07 | 15.85 | 0.07 |
| (commercial product D) | | | |
| Comparative Example 5 | 5.45 | 51.51 | 0.11 |
| (commercial product E) | | | |
| Comparative Example 6 | 0.79 | 7.42 | 0.11 |
| (commercial product F) | | | |
| Comparative Example 7 | 0.46 | 4.66 | 0.1 |
| (commercial product G) | | | |

As shown in Table 2, the pet food of Example 1 is a higher opening area ratio of the first surface (opening area ratio of the third surface) than the pet foods of Comparative Examples 1 to 7. In addition, in the commercially available pet foods of Comparative Examples 1 to 7, an opening area ratio of the first surface is not 10% or more.

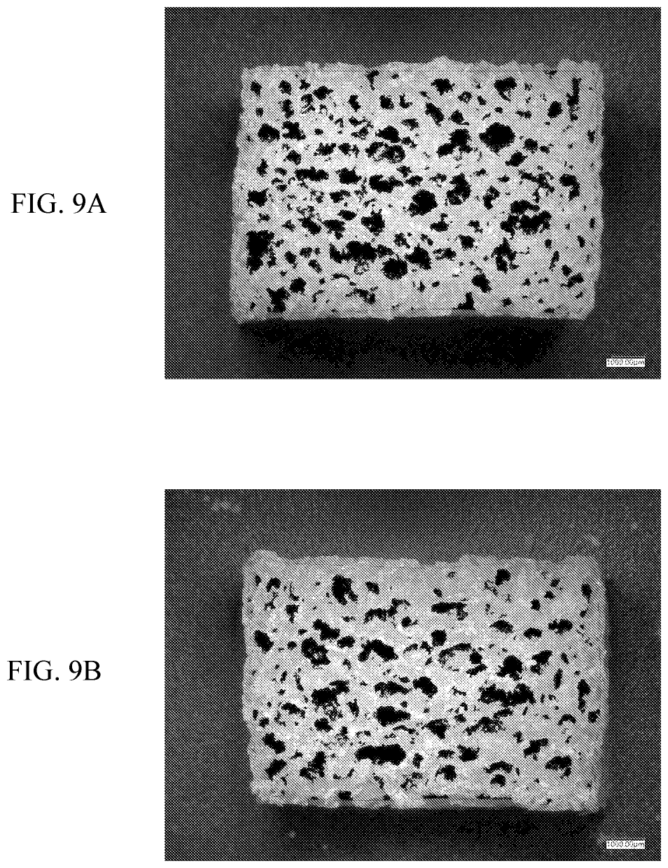

FIG. 9A shows an image when measuring the opening area ratio of the first surface of the pet food of Example 1 and FIG. 9B shows an image when measuring the opening area ratio of the cross section (a plane parallel to the first surface).

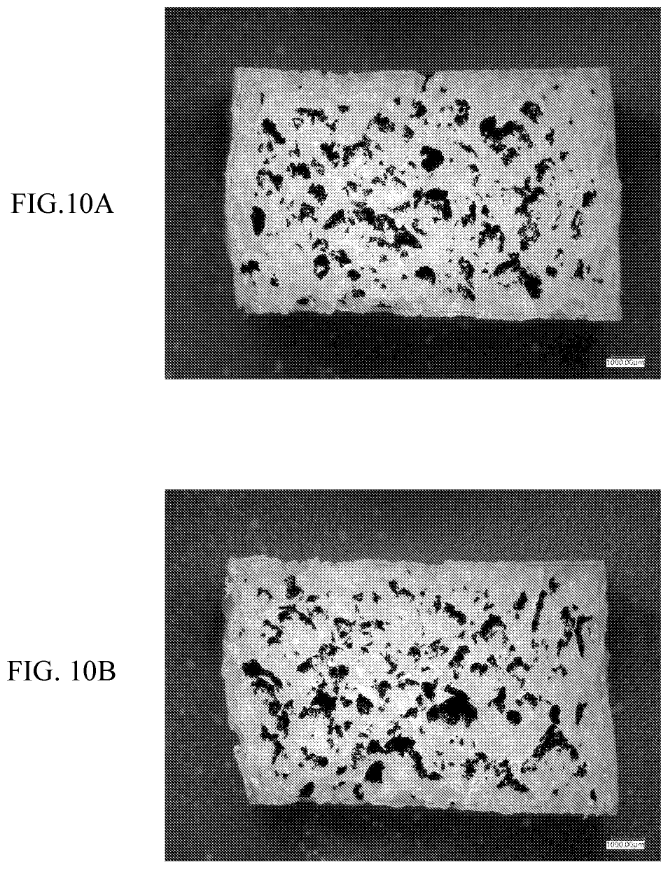

FIG. 10A shows an image when measuring the opening area ratio of the third surface of the pet food of Example 1 and FIG. 10B shows an image when measuring the opening area ratio of the cross section (a plane parallel to the third surface).

As shown in FIG. 9 and FIG. 10, it could be confirmed that the distributions of the openings the first surface and the cross section (a plane parallel to the first surface) of the pet food of Example 1 and the distributions of the openings of the third surface and the cross section (a plane parallel to the third surface) of the pet food of Example 1 are similar to each other.

In addition, as shown in Table 2, in the pet food of Example 1, the ratio of the opening area ratio of the first surface (the ratio of the opening area ratio of the third surface) is closer to 1 as compared to the pet foods of Comparative Examples 1 to 7. From this, it was confirmed that the pet food of Example 1 had openings more uniform on the surface and inside than the pet foods of Comparative Examples 1 to 7.

<Evaluation of Hardness>

For the first surface, the third surface, and the fifth surface of the pet food of Example 1, the hardness was measured by the following method.

In the present specification, the hardness of the pet food is a value obtained by the following measurement method.

A breaking force in a case where the pet food is compressed at a constant compression rate, was measured using a compression tester (texture analyzer, model number: EZ-SX, manufactured by Shimadzu Corporation).

Specifically, one pet food of Example 1 was placed on the pan, and the test force while the plunger is pressed vertically from directly above at a constant rate was measured. The pet food was placed such that the surface in contact with the plunger was the first surface, the third surface, or the fifth surface, the measurement was repeated times for each, and the average value was obtained.

The unit was converted to Newtons (N) by multiplying the numerical value of the breaking force (unit: kgw) measured by the compression tester by 9.8.

Measurement conditions are as follows.
Plunger: 10 mm in width, 20 mm in length, 1 mm in thickness at the leading end, wedge-shaped plunger
Platform: a flat pan with a diameter of 100 mm
Compression rate: 60 mm/min
Lowest point of plunger: 6 mm for the first surface and the third surface, 10 mm for the fifth surface
Measured temperature: 25° C.

Table 3 shows the results.

TABLE 3

| | | Hardness |
|---|---|---|
| | | (N) |
| Example 1 | The first surface | 25.8 |
| | The third surface | 12.3 |
| | The fifth surface | 38.4 |

As shown in Table 3, the pet food of Example 1 has different hardness depending on the surface, it was confirmed that a plurality of textures can be enjoyed when grinding the pet food.

<Evaluation of Water Absorption Rate>

The water absorption rate for 5, 30, and 60 seconds of the pet food of Example 1 were measured in a case where the water temperature was 20° C. in the same manner as the water absorption rate for 5, 30, and 60 seconds described above. Table 4 shows the results.

TABLE 4

| | Water absorption rate (mass %) | | |
|---|---|---|---|
| | Water absorption | Water absorption | Water absorption |
| | rate for 5 | rate for 30 | rate for 60 |
| | seconds | seconds | seconds |
| Example 1 | 134 | 152 | 163 |

As shown in Table 4, the pet food of Example 1 has a high water absorption rate.

<Evaluation of Hardness>

The hardness of the grains of the pet food after being immersed in water for 5, 30, and 60 seconds (hardness after immersion for 5 seconds, hardness after immersion for seconds, hardness after immersion for 60 seconds) of the fifth surface of the pet food of Example 1 immersed in water at 20° C. in the same manner as the hardness of the grains of the pet food immersed in water for 5, 30, and 60 seconds described above was measured. Table 5 shows the results. The hardness after immersion for 0 seconds in Table 5 is the same as the hardness of the fifth surface shown in <Evaluation of hardness> described above.

TABLE 5

| | Hardness after immersion (N) | | | |
|---|---|---|---|---|
| | Hardness | Hardness | Hardness | Hardness |
| | after | after | after | after |
| | immersion | immersion | immersion | immersion |
| | for 0 seconds | for 5 seconds | for 30 seconds | for 60 seconds |
| Example 1 | 38.4 | 7.9 | 3.2 | 3 |

As shown in Table 5, the hardness of the pet food of Example 1 changed only by being immersed in water for several seconds.

<Evaluation of Palatability>

(Production of Pet Food Having Openings 2)

The pet foods of Examples 2 and 3, and Reference Example 1 which is hexahedral (a longitudinal length of 8 mm (X direction)×a lateral length of 8 mm (Y direction)×a height (thickness) of 11.5 mm (Z direction)), were produced in the same manner as in Example 1 described above. A specific producing method is as follows.

In the following description and Table 4, “surface having openings” means a surface having an opening area ratio of 10% or more as measured by the method described above. In addition, the “surface without openings” is a surface having an opening area ratio of less than 10% as measured by the method described above.

### Pet Food of Example 2

The pet foods of Example 2 which are hexahedral (a longitudinal length of 8 mm (X direction)×a lateral length of 8 mm (Y direction)×a height (thickness) of 11.5 mm (Z direction)), were obtained in the same manner as in Example 1 described above except that the die plate of the extruder was changed and the porous dough was cut from CD with the cutter. Since the cut surface is a surface having openings, the pet food of Example 2 has two surfaces having openings. The opening area ratio of the surface having openings of the pet food of Example 2 is approximately the same as the opening area ratio of the first surface and the third surface of the pet food of Example 1, and the opening area ratio of the surface without openings of the pet food of Example 2 was approximately the same as the opening area ratio of the fifth surface of the pet food of Example 1.

### Pet Food of Example 3

The die plate of the extruder was changed, and the hexahedral pet food slightly larger than the pet food of Example 1 was obtained in the same manner as in Example 1. The non-cut surfaces of the pet food (surfaces corresponding to the fifth surface and the sixth surface of the pet food of Example 1) were cut with a cutter, and the pet food of Example 3 which has openings over the whole periphery and which is hexahedral (a longitudinal length of 8 mm (X direction)×a lateral length of 8 mm (Y direction)×a height (thickness) of 11.5 mm (Z direction)) was obtained. Since the cut surface is a surface having openings, the pet food of Example 3 has six surfaces having openings. The opening area ratio of the surface having openings of the pet food of Example 3 was approximately the same as the opening area ratio of the first surface and the third surface of the pet food of Example 1.

### Pet Food of Reference Example 1

The pet foods of Reference Example 1 which are hexahedral (a longitudinal length of 8 mm (X direction)×a lateral length of 8 mm (Y direction)×a height (thickness) of 11.5 mm (Z direction)) were obtained in the same manner as in Example 1 except that the die plate of the extruder was changed and the raw material mixture was cut with the cutter immediately after being discharged from the extruder. The pet food of Reference Example 1 did not have a surface having openings.

Palatability Test

100 g of each of the pet foods of Examples 1 to 3 and Reference Example 1 was put into a dish on a dog having an empty stomach (body weight of 5 kg or less), the remaining amount of each pet food was measured after 5 minutes, and the palatability was evaluated according to the following criteria. Table 6 shows the results.
A: Less than 5 g
B: 5 g or more and less than 25 g
C: 25 g or more

TABLE 6

| | Number of surfaces | Number of surfaces | |
|---|---|---|---|
| | having openings | without openings | Palatability |
| Example 1 | 4 | 2 | A |
| Example 2 | 2 | 4 | B |
| Example 3 | 6 | 0 | B |
| Reference | 0 | 6 | C |
| Example 1 | | | |

As described above, it could be confirmed that the pet food of Examples has a surface having an opening area ratio of 10% or more, and thus it is easy to grind while maintaining the chewability, and has high palatability, compared to the pet food of the Reference Example.

In addition, among the examples, the pet food of Example 1 which has four surfaces having openings and two surfaces without openings, has the highest palatability.

Although examples of the present invention have been described above, the present invention is not limited to these examples. Configurations can be added, omitted, and replaced, and other modifications can be made within a range not departing from the spirit of the present invention. The present invention is not limited by the foregoing description, and is limited only by the appended claims.

### REFERENCE SIGNS LIST

C10: pet food
C1: first surface
C2: second surface
C3: third surface
C4: fourth surface
C5: fifth surface
C6: sixth surface
1: opening
D10: pet food
D1: first surface
D2: second surface
D3: third surface
D4: fourth surface
D5: fifth surface
D6: sixth surface
2: opening
101: extruder
102: belt conveyor
103: cooler
104: cutter

What is claimed is:

1. A pet food comprising:
a first surface on which the pet food is projected in a first direction; and
a plurality of openings, wherein
the pet food has an opening area ratio of 10% or more on the first surface.

2. The pet food according to claim 1, further comprising:
a second surface on which the pet food is projected in a direction other than the first direction, wherein
an opening area ratio of a second surface is 8% or less.

3. The pet food according to claim 1, further comprising:
a second surface on which the pet food is projected on an A side in a second direction that intersects the first direction; and
a third surface on which the pet food is projected on a B side in the second direction, wherein
an opening area ratio of at least one of the second surface and the third surface is 10% or more.

4. The pet food according to claim 3, wherein opening area ratios of the second surface and the third surface are each 10% or more.

5. The pet food according to claim 1, wherein a ratio of the opening area ratio of the first surface to the opening area ratio of a cross section where the pet food is cut orthogonal to the first direction is 0.4 to 2.

6. The pet food according to claim 1, wherein a ratio of the opening area ratio of the first surface to the opening area ratio of a cross section where the pet food is cut such that the first surface is divided equally is 0.4 to 2.
